(19) United States
(12) Patent Application Publication
(10) Pub. No.: US 2008/0078578 A1
(43) Pub. Date: Apr. 3, 2008

(54) Transmission system and integrated transmission cable thereof

(75) Inventors: Yu-Jen Wang, Taoyuan Hsien (TW); Wei-Pin Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/902,028

(22) Filed: Sep. 18, 2007

(30) Foreign Application Priority Data
Sep. 29, 2006 (CN) 095136194

(51) Int. Cl. H01R 4/00

(52) U.S. Cl. 174/72 R

(57) ABSTRACT

An integrated transmission cable includes a multi-core cable, a universal serial bus (USB) connector, a network connector and a common connector. The multi-core cable has a first core group and a second core group. The USB connector is electrically connected with a first end of the first core group. The network connector is electrically connected with a first end of the second core group. The common connector is electrically connected with second ends of the first core group and the second core group. A transmission system is also disclosed.

### CROSS REFERENCE TO RELATED APPLICATIONS

This Non-provisional application claims priority under 35 U.S.C. §119(a) on Patent Application No(s). 095136194 filed in Taiwan, Republic of China on Sep. 29, 2006, the entire contents of which are hereby incorporated by reference.

### BACKGROUND OF THE INVENTION

1. Field of Invention

The invention relates to a transmission system and an integrated transmission cable thereof. In particularly, the invention relates to a transmission system, in which a universal serial bus (USB) transmission cable is integrated with a network transmission cable, and an integrated transmission cable of the transmission system.

2. Related Art

With the progress of the electronic technology and the flourishing development of the network, current electronic devices, such as desktop computers or notebook computers, are usually equipped with a network transmission port, a USB interface and other transmission ports. FIG. 1 is a schematic illustration showing a conventional USB transmission cable 11 and a network transmission cable 12. As shown in FIG. 1, the USB transmission cable 11 has two four-pin connectors 111 and 111A, and a four-core transmission cable 112. The network transmission cable 12 has two eight-pin connectors 121 and an eight-core transmission cable 122. When an electronic device (not shown) is connected with an Intranet through the network transmission cable 12, the electronic device has to provide a power to the Intranet. That is, the electronic device must have an AC/DC power converter. In addition, if the electronic device has to be connected with a USB device and the Intranet simultaneously, the USB transmission cable 11 and the network transmission cable 12 must respectively be provided. In addition, the electronic device must be equipped with a USB connector and a network connector. However, since various transmission cables and various connectors are necessary, the miniaturization of the electronic device is influenced. Moreover, the material cost, the assembling cost and the managing cost cannot be effectively reduced.

Thus, it is an important subject to provide a transmission system and an integrated transmission cable thereof, in which USB and network transmission cables and connection interfaces thereof are integrated so that the circuit layout of the electronic product is simplified, the flexibility of the circuit design is increased, and the numbers of the connectors and the transmission cables can be reduced.

### SUMMARY OF THE INVENTION

In view of the foregoing, the invention is to provide a transmission system and an integrated transmission cable thereof, in which a universal serial bus (USB) cable, a network transmission cable and connection interfaces thereof are integrated so that the circuit layout of the electronic product is simplified, the flexibility of the circuit design is increased, and the numbers of the connectors and the transmission cables can be reduced.

In view of the foregoing, the invention further provides a transmission system and an integrated transmission cable thereof configured so that a working power can be directly provided to an electronic device through a USB.

To achieve the above, the invention discloses an integrated transmission cable including a multi-core cable, a USB connector, a network connector and a common connector. The multi-core cable has a first core group and a second core group. The USB connector is electrically connected with a first end of the first core group. The network connector is electrically connected with a first end of the second core group. The common connector is electrically connected with second ends of the first and second core groups.

To achieve the above, the invention also discloses a transmission system including an integrated transmission cable and an electronic device. The integrated transmission cable includes a multi-core cable, a USB connector, a network connector and a common connector. The multi-core cable has a first core group and a second core group. The USB connector is electrically connected with a first end of the first core group. The network connector is electrically connected with a first end of the second core group. The common connector is electrically connected with second ends of the first and second core groups. The electronic device is electrically connected with the common connector.

As mentioned above, when the transmission system and the integrated transmission cable thereof are applied to the condition with the transmission rate of 10/100M Base-T, the four pins of the USB are integrated with the four idle pins of eight pins of the network transmission cable so that independent transmission cables are integrated in the same transmission cable and share the connector. Compared with the prior art, the USB and the network transmission cable and the connection interfaces thereof are integrated so that the circuit layout of the miniaturized electronic product can be simplified. In addition, four pins of the USB can be freely connected to four idle pins of the transmission cable according to the circuit layout so that the flexibility of designing the circuit can be increased, the numbers of the connectors and the transmission cables can be reduced. Furthermore, a working power can be provided to the electronic device or the network device through the USB directly.

### BRIEF DESCRIPTION OF THE DRAWINGS

The invention will become more fully understood from the subsequent detailed description and the accompanying drawings, which are given by way of illustration only, and thus are not limitative of the present invention, and wherein:

FIG. 1 is a schematic illustration showing a conventional USB transmission cable and a network transmission cable;

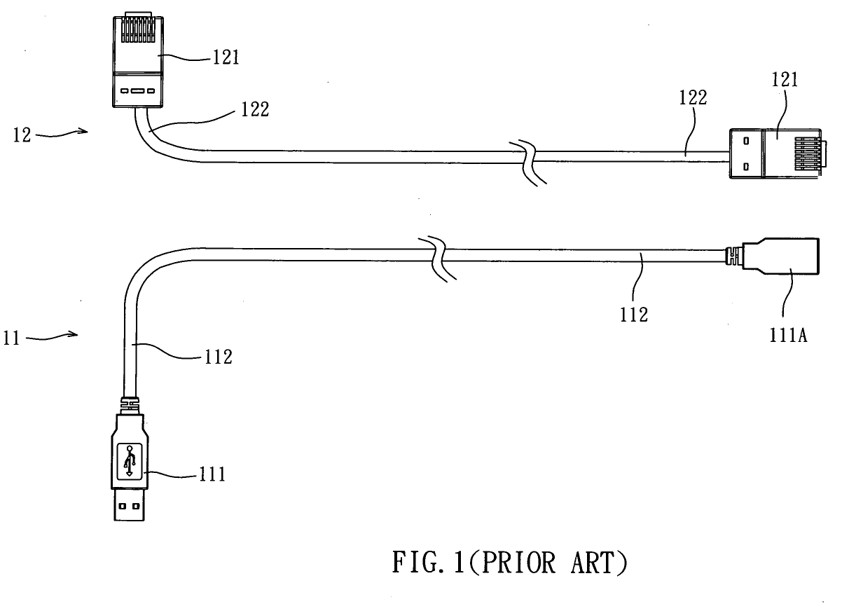

FIG. 2 is a schematic illustration showing an integrated transmission cable according to an embodiment of the invention;

FIG. 3 is a schematic illustration showing the cable arrangement of the integrated transmission cable according to the embodiment of the invention; and

FIG. 4 is a schematic illustration showing a transmission system and an integrated transmission cable thereof according to the embodiment of the invention.

### DETAILED DESCRIPTION OF THE INVENTION

The present invention will be apparent from the following detailed description, which proceeds with reference to the accompanying drawings, wherein the same references relate to the same elements.

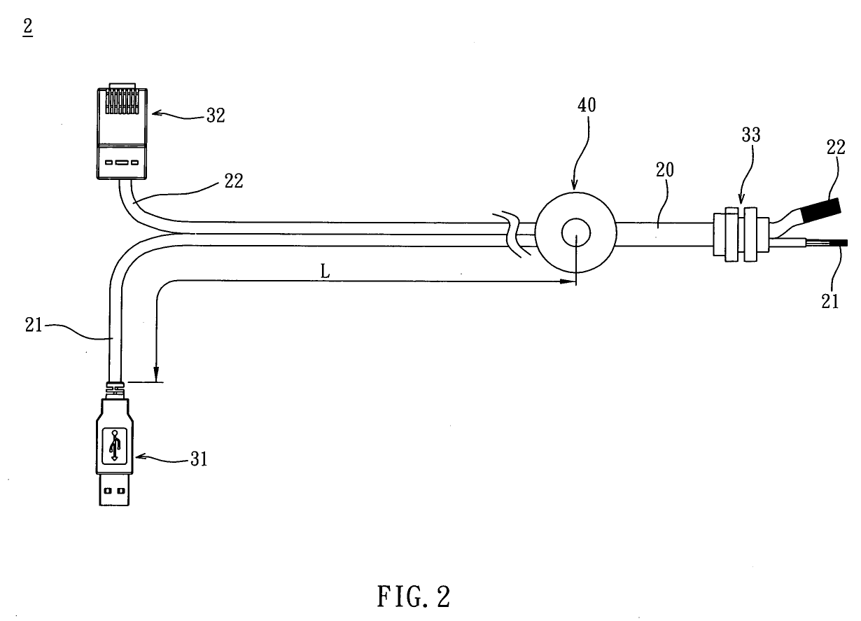

Referring to FIG. 2, an integrated transmission cable 2 according to an embodiment of the invention includes a multi-core cable 20, a USB connector 31, a network connector 32 and a common connector 33. The multi-core cable 20 has a first core group 21 and a second core group 22. A first end of the first core group 21 is electrically connected with the USB connector 31. A first end of the second core group 22 is electrically connected with the network connector 32. The core groups 21 and 22 are gathered together to form the multi-core cable 20 and then electrically connected with the common connector 33. That is, the common connector 33 is electrically connected with second ends of the first and second groups 21, 22.

In the integrated transmission cable 2, a portion of the first core group 21 adjacent to the first end of the first core group 21 is separated from a portion of the second core group 22 adjacent to the first end of the second core group 22 so that the multi-core cable 20 has a Y shape. In addition, the integrated transmission cable 2 further includes an adjusting element 40 located at a bifurcation point of the first core group 21 and the second core group 22. The adjusting element 40 adjusts lengths L of the separated portions of the Y-shaped cable 20. Preferably, the length L of the separated portion of the first core group 21 is not greater than 5 meters, and the integrated transmission cable 2 is adapted to a network transmission rate of 10/100M Base-T. In the embodiment, the adjusting element 40 is a wire reel.

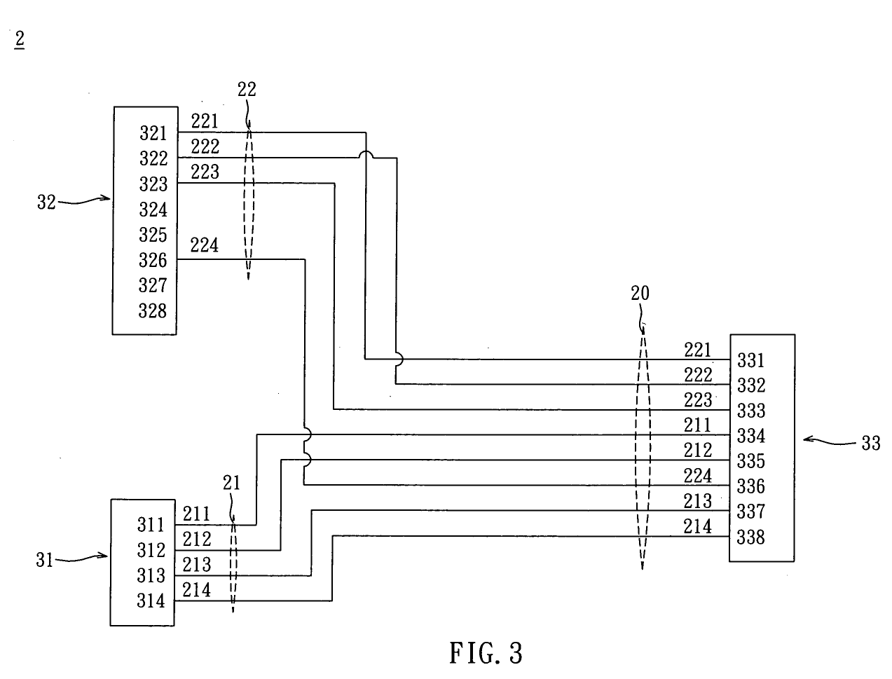

As shown in FIG. 3, the multi-core cable 20 may be an eight-core network transmission cable, such as CAT5, the first core group 21 has four cores 211, 212, 213 and 214, and the second core group 22 has four cores 221, 222, 223 and 224. The USB connector 31 has four pins 311, 312, 313 and 314 respectively electrically connected with the cores 211, 212, 213 and 214. In this embodiment, the network connector 32 is an RJ-45 connector and has eight pins 321, 322, 323, 324, 325, 326, 327 and 328. Herein, the pins 321, 322, 323 and 326 are respectively electrically connected with the first ends of the cores 221, 222, 223 and 224. When the network transmission rate is 10/100M Base-T, the pins 324, 325, 327 and 328 of the RJ-45 connector are idle pins which are not connected with the cores. The common connector 33 has eight pins 331, 332, 333, 334, 335, 336, 337 and 338 for connecting the second ends of the cores 211, 212, 213 and 214 of the first core group 21 with the second ends of the cores 221, 222, 223 and 224 of the second core group 22, respectively.

In this embodiment, the connection order of the multi-core cable 20 and the cables between the connectors 31 to 33 will be described in the following. The pins 311, 312, 313 and 314 of the USB connector 31 include two power pins and two data pins, and the arrangement order of the four pins includes, for example but not limited to, a power receiving end (Vcc, the pin 311), a data transmitting end (DATA-, the pin 312), a data receiving end (DATA+, the pin 313) and a power ground (GND, the pin 314). The pins 311, 312, 313 and 314 are electrically connected with the first ends of the cores 211, 212, 213 and 214 of the first core group 21, respectively. The second end of the first core group 21 is electrically connected with, for example but not limited to, the pins 334, 335, 337 and 338 of the common connector 33, respectively. Thus, the USB connector 31 can provide the 5-volt power to the common connector 33 through the power pins 311 and 314 so that the 5-volt power can be used by an electronic device or a network device.

In this invention, the pins 311, 312, 313 and 314 of the USB connector 31 and the idle pins 324, 325, 327 and 328 of the network connector 32 are integrated together and electrically connected with the pins 331, 332, 333, 334, 335, 336, 337 and 338 of the common connector 33. Thus, the USB transmission and the network transmission which are independent from each other can be integrated in the same transmission cable and share the common connector. The idle pins 324, 325, 327 and 328 in the network connector 32, which integrates the pins 311, 312, 313 and 314 of the USB connector 31, are arranged in a manner that is not particularly restricted. For example, as shown in Table 1, when the pin 311 of the USB connector 31 is connected with the idle pin 324 of the network connector 32, the other pins 312, 313 and 314 of the USB connector 31 can be connected with the other idle pins 325, 327 and 328 of the network connector 32 in a non-limitative manner. Thus, there are six arrangement variations, as listed in Table 1. Similarly, when the pins 312, 313 and 314 of the USB connector 31 are connected with the idle pin 324 of the network connector 32, six different arrangements also exist. Thus, the pins 311, 312, 313 and 314 of the USB connector 31 can be connected with the idle pins 324, 325, 327 and 328 of the network connector 32 according to 24 variations in total. Similarly, the used pins 321, 322, 323 and 326 of the network connector 32 can also be arranged according to various manners, so the flexibility of designing the pins of the common connector 33 can be increased.

TABLE 1

| | | | | | | | | |
|---|---|---|---|---|---|---|---|---|
| Pin of common | 331 | 332 | 333 | 334 | 335 | 336 | 337 | 338 |
| connector | | | | | | | | |
| Pin of network | 321 | 322 | 323 | | | 326 | | |
| connector | | | | | | | | |
| Pin of USB | | | | 311 | 312 | | 313 | 314 |
| | | | | 311 | 312 | | 314 | 313 |
| | | | | 311 | 313 | | 312 | 314 |
| | | | | 311 | 313 | | 314 | 312 |
| | | | | 311 | 314 | | 312 | 313 |
| | | | | 311 | 314 | | 313 | 312 |

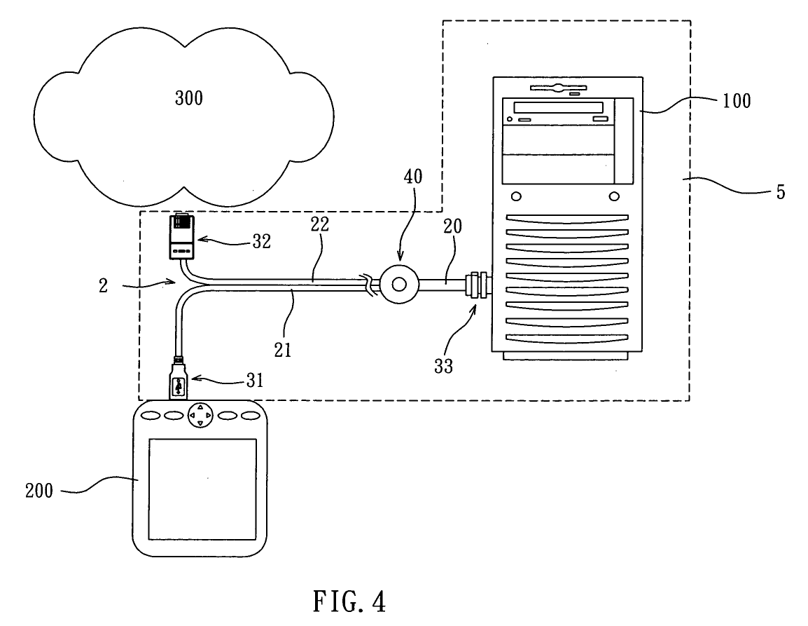

The integrated transmission cable 2 of the embodiment can be applied to the electrical connection and the data transmission between the electronic device and other electronic devices, a network device or a USB interface device. Referring to FIG. 4, a transmission system 5 according to the embodiment of the invention includes an integrated transmission cable 2 and a first electronic device 100 electrically connected with the common connector 33 of the integrated transmission cable 2. The integrated transmission cable 2 is connected to a second electronic device 200 and a network 300. Each of the first electronic device 100 and the second electronic device 200 may be, for example but not limited to, a personal computer (PC), a personal digital assistant (PDA) or a mobile phone. In particularly, the personal computer may be a desktop computer, a notebook computer or a tablet computer. In this illustrated embodiment, the first electronic device 100 is a personal computer, and the second electronic device 200 is a personal digital assistant (PDA).

The integrated transmission cable 2 is connected with the second electronic device 200 through the first core group 21 and the USB connector 31, and connected with the network 300 through the second core group 22 and the network connector 32. Under this architecture, different devices are connected with the first electronic device 100 through the common connector 33. Thus, the numbers of the connectors and the transmission cables can be reduced according to the integrated arrangement of the integrated transmission cable 2 and the common connector 33. In this embodiment, the network 300 may be an Intranet or an Internet. In addition, the USB connector 31 can provide a 5-volt power from the second electronic device 200 to the common connector 33 through the power pins 311 and 314, so that the power can be provided to the first electronic device 100.

In summary, when the transmission system and the integrated transmission cable thereof are applied to the condition with the transmission rate of 10/100M Base-T, the four pins of the USB are integrated with the four idle pins of eight pins of the network transmission cable so that independent transmission cables are integrated in the same transmission cable and share the connector. Compared with the prior art, the USB and the network transmission cable and the connection interfaces thereof are integrated so that the circuit layout of the miniaturized electronic product can be simplified. In addition, four pins of the USB can be freely connected to four idle pins of the transmission cable according to the circuit layout so that the flexibility of designing the circuit can be increased, the numbers of the connectors and the transmission cables can be reduced. Furthermore, a working power can be provided to the electronic device or the network device through the USB directly.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transmission cable comprising:
a multi-core cable having a first core group and a second core group;
a universal serial bus (USB) connector electrically connected with a first end of the first core group;
a network connector electrically connected with a first end of the second core group; and
a common connector electrically connected with a second end of the first core group and a second end of the second core group.

2. The cable according to claim 1, wherein the USB connector comprises two power pins and two data pins.

3. The cable according to claim 2, wherein the USB connector provides a power to the common connector through the power pins.

4. The cable according to claim 3, wherein the power has a voltage equal to 5 volts.

5. The cable according to claim 1, wherein the common connector has eight pins, the first core group is electrically connected with four of the eight pins, and the second core group is electrically connected with the other four of the eight pins.

6. The cable according to claim 1, wherein a portion of the first core group near the first end of the first core group is separated from a portion of the second core group near the first end of the second core group so that the multi-core cable has a Y shape.

7. The cable according to claim 6, further comprising:
an adjusting element for adjusting lengths of the separated portions of the Y-shaped multi-core cable.

8. The cable according to claim 7, wherein the adjusting element is a wire reel.

9. The cable according to claim 7, wherein the length of the separated portion of the first core group is not greater than 5 meters.

10. The cable according to claim 1, wherein the network connector is an RJ45 connector adapted to a network transmission rate of 10/100M Base-T.

11. A transmission system comprising:
an integrated transmission cable, which comprises a multi-core cable, a universal serial bus (USB) connector, a network connector and a common connector, wherein the multi-core cable has a first core group and a second core group, the USB connector is electrically connected with a first end of the first core group, the network connector is electrically connected with a first end of the second core group, and the common connector is electrically connected with second ends of the first core group and the second core group; and
an electronic device electrically connected with the common connector.

12. The transmission system according to claim 11, wherein the USB connector comprises two power pins and two data pins.

13. The transmission system according to claim 12, wherein the USB connector provides a power to the electronic device through the power pins.

14. The transmission system according to claim 11, wherein the common connector has eight pins, the first core group is electrically connected with four of the eight pins, and the second core group is electrically connected with the other four of the eight pins.

15. The transmission system according to claim 11, wherein a portion of the first core group near the first end of the first core group is separated from a portion of the second core group near the first end of the second core group so that the multi-core cable has a Y shape.

16. The transmission system according to claim 15, further comprising:
an adjusting element for adjusting lengths of the separated portions of the Y-shaped multi-core cable.

17. The transmission system according to claim 16, wherein the length of the separated portion of the first core group is not greater than 5 meters.

18. The transmission system according to claim 11, wherein the transmission system is adapted to a network transmission rate of 10/100M Base-T.

19. The transmission system according to claim 11, further comprising another electronic device connected to the USB connector.

20. The transmission system according to claim 11, further comprising a network connected to the network connector.
